(19) United States
(12) Patent Application Publication
(10) Pub. No.: US 2014/0340484 A1
(43) Pub. Date: Nov. 20, 2014

(54) ILLUMINATION APPARATUS AND METHOD FOR THE GENERATION OF AN ILLUMINATED REGION FOR A 3D CAMERA

(71) Applicant: SICK AG, Waldkirch (DE)

(72) Inventors: Thorsten PFISTER, Waldkirch (DE); Nikolaus SCHILL, Waldkirch (DE)

(73) Assignee: SICK AG, Waldkirch (DE)

(21) Appl. No.: 14/279,366

(22) Filed: May 16, 2014

(30) Foreign Application Priority Data
May 17, 2013 (DE) 102013105105.7

(51) Int. Cl. G03B 15/06; H04N 13/02

(52) U.S. Cl. CPC G03B 15/06; H04N 13/0253
USPC 348/46; 362/16; 362/17

(57) ABSTRACT

An illumination apparatus (16) for a 3D camera (10) for the generation of an illuminated region (22) having a homogeneous intensity distribution which is nevertheless an increased intensity distribution in the boundary regions of the illuminated region (22), wherein the illumination apparatus (16) comprises at least one light source (26) having a main radiation direction, as well as a lateral reflector (30) circumferentially arranged about the main radiation direction (28). In this connection an additional central reflector (32) is arranged in the main radiation direction (28) in order to redistribute central light portions of the light transmitted by the light source (26) outwardly by reflection at the central reflector (32) and at the lateral reflector (30).

The invention relates to an illumination apparatus and to a method for the generation of an illuminated region for a 3D camera in accordance with the preamble of claim 1 and claim 13 respectively.

In contrast to common two-dimensional cameras, 3D cameras also generate distance information as an additional dimension of the image data. Different techniques are known for this purpose. Stereoscopic cameras record the scenery at least twice from different perspectives, sort like structural elements in the two images with respect to one another and calculate the distance from the disparity and the known perspectives in accordance with the example of human spatial vision. Pattern-based methods, such as for example, light section processes, recognize distances by means of distortions of a taught or otherwise known illumination pattern. Time of flight of light cameras determine the time between transmission and reception of a light signal and indeed, in contrast to laser scanners or distance probes not only once, but spatially resolved per pixel element of the image sensor, such as for example, in a method known as photon mixed detection.

One can split these 3D methods into active and into passive methods in dependence of whether the 3D camera has an own illumination or relies on the ambient lighting. Pattern-based methods, as well as time of flight of light methods are inherently active, since the illumination is an indispensable part of the distance determination. Stereo methods can in principle both be active and passive. Having regard to passive stereoscopy, however, precisely for larger, homogeneous regions of the scenery and in this way regions of the scenery without structure have the problem that no unambiguous association of image features and in this way no reliable estimation of disparity is possible.

A known interference effect during the image detection is the so-called boundary drop. An inhomogeneous distribution of the intensity which becomes smaller at the boundary with respect to the center is understood by this. Active 3D methods suffer twice from a boundary drop as, on the one hand, the image sensor receives less light at the image boundaries due to the boundary drop of its objective, on the other hand, the scenery is even more poorly illuminated due to comparable inhomogeneities of the illumination in the boundary region.

Different possibilities are known in order to compensate the boundary drop in the prior art. One approach consists thereof in arranging a micro-lens field downstream of the illuminated laser diodes which carry out a certain light redistribution towards the boundaries of the visible region. This means a comparatively high optical demand in effort and cost which also does not completely overcome the problem.

In a different common system, a plurality of LED light sources are equipped with a respective individual transmission lens. The individual illumination fields arising thereby are aligned by a corresponding arrangement of the transmission lenses with respect to the light sources at different positions in the visible range of the 3D camera, whereby an increase in intensity in the boundary regions is achieved through a shift of illumination fields from the center of the visible region. However, this includes considerable disadvantages, in particular in connection with the time of flight of light method, since the resulting overall illumination results for nearly every pixel as a different super-position of the individual light sources. Having regard to time of flight of light method one however generally wants to have one optical reference path in order to be able to consider drifts which are not dependent on the time of flight of light. When the light composition changes from pixel to pixel, an optical reference path would in principle have to be formed for each pixel range or even for each individual pixel which would be extremely difficult from a technological point of view if not impossible. In contrast to this, systematic measurement deviations would be introduced without such a reference path which in practice can frequently not be tolerated. A further disadvantage of the use of a plurality of LED light sources consists therein that considerable deviations in performance can arise due to effects, such as component tolerances, temperature dependencies, noise or even failures. Thereby the intensity distribution changes locally and in this way generates further measurement errors.

It is furthermore known to provide the light source with lateral reflectors in order to achieve a deflection with respect to the center in the outer part of the illumination field. Different systems only use the inner region of the radiation profile in which the intensity is approximately constant. By means of both measures at best a homogeneous light distribution can be achieved but without an increase in the boundary region.

Having regard to stereoscopic camera systems, such as for example illustrated in the US 2007/0263903 A1 diffractive optical elements are also used in the illumination unit. However, these primarily serve the purpose of generating a structured illumination pattern and do not ensure an effective homogeneous intensity distribution by compensating the boundary region drop. However, also the idea of additionally compensating the boundary drop is mentioned, for example, in the DE 20 2008 013 217U1.

For two-dimensional cameras it is for example known from the DE 102 04 939A1 to use a Fresnel lens for a homogeneous illumination. Camera illumination units can also comprise optical elements in micro-shape, Fresnel shape or embodiments as diffractive elements in accordance with the DE 10 2006 023 142A1. In this way, however no simple optical means are further mentioned which sufficiently compensate the problem of the boundary region drop.

For this reason, it is the object of the invention to improve the illumination for a 3D camera.

This object is satisfied by an illumination apparatus and by a method for the generation of an illuminated region for a 3D camera in accordance with claim 1 and claim 13 respectively. In this connection the invention is based on the idea of redistributing light within the illuminated region in order to achieve a homogeneous intensity distribution with a targeted increase of the intensity distribution in the boundary regions. The illumination thus shows no flat intensity distribution, but rather is effectively homogeneous in the sense that the boundary drop of the illuminated region and possibly also the boundary drop of a receiving objective of a 3D camera is compensated by corresponding increases in intensity. In order to generate such intensity distributions a combination of a circumferentially arranged lateral reflector and a centrally arranged central reflector in a main radiation direction is used. The main radiation direction preferably corresponds to the optical axis of the light source and forms an axis of symmetry of the illumination apparatus. The shaping and the arrangement of the two reflectors is such that light is redistributed from the center towards the boundary. In this connection also the center does not remain non-illuminated, since the lateral reflector redistributes the light portions which do not stem from the central reflector in the direction with respect to the center and in this way also deflects light into the central illuminated region shaded on the direct path by the central reflector.

The invention has the advantage that at least a boundary drop of the intensity of the illumination apparatus and preferably at the same time a second boundary drop of the intensity received by a 3D camera is compensated by a boundary drop of the reception objective. This leads to a constant geometric resolution of the article in the complete measurement field independent of the lateral position of the article, wherein in particular articles present at the boundary of the viewing fields can be recognized better and can be localized better. In this connection precisely for time of flight of light methods interfering multiple paths are avoided by a corresponding shaping and arrangement of the two reflectors. The illumination in accordance with the invention is very efficient from an energy point of view, since the transmission light is utilized by a redistribution to a high level of 80% and more within the desired illuminated region. In this connection the illumination apparatus requires less construction space and thus enables a smaller and flatter shape of construction, while the fewer required components can be manufactured more cost-effectively. Moreover, the reflectors ensure a good thermal connection of the light source and in this way a high lifetime.

The lateral reflector preferably has the shape of a hollow cone or of a hollow pyramid. The axis of this hollow cone preferably coincides with the main radiation direction and in this way with the optical axis of the light source in order to obtain a symmetrical arrangement. The hollow cone ensures the desired reflection by an internal mirror coating. The jacket surface of the hollow cone is preferably directly adjacent to the light source in order to ensure a simple connection from a construction point of view and from a thermal point of view, as well as an optical termination. Further alternatives of the shape of the lateral reflector are plausible, for example, a section from a paraboloid, an ellipsoid or also from a free form surface.

The lateral reflector preferably has the shape of at least two hollow truncated cones arranged on top of one another or of hollow truncated pyramids arranged on top of one another. In this connection the angles of the respective trunks are different so that a step-like extent arises. Such stacked or convoluted hollow trunks allow an adaption of the radiation characteristics by means of the angle in such a way that the illumination field has the desired homogeneity and boundary loss compensation.

The central reflector preferably has a tapering shape. This tip preferably points in the direction of the light source, whereas the central reflector having a central axis opens into the tip which is arranged at the optical axis of the light source. The central reflector then has the desired reflection properties through the outer mirrored surface.

The central reflector preferably has a rotationally symmetric shape. This corresponds to a rotationally symmetric radiation characteristic of the light source or of a homogeneous illuminated region respectively in both lateral directions. When the radiation characteristics has known deviations or if an asymmetrical illuminated region is desired, a non-rotationally symmetric shape of the central reflector can alternatively be selected.

The central reflector preferably has the shape of a wedge or of a cone. In this connection a wedge is only effective in a lateral axis, a cone in contrast to this is effective in both lateral axes. In a corresponding section such a geometry respectively provides an inclined mirrored contour which in cooperation with the lateral reflector generates the desired redistribution. Alternative geometries ensure the targeted deviation through a parabolic central reflector or through a free form surface. Also an alternative embodiment as a web or as a crossed web is plausible.

An optical element is preferably arranged in the optical path of the light source for the additional light redistribution, the optical element being arranged downstream of the lateral reflector and of the central reflector. This optical element acts in addition to the two reflectors in order to achieve a desired illumination distribution.

The optical element probably has a diffractive optical element or a Fresnel lens. A diffractive optical element is generally sensitive with respect to the bandwidth and the divergence of the light source which, however, does not play a large role for a homogeneous illumination. A different known problem is represented by the 0^{th} order of diffraction in which, in particular from the point of view of eye protection, too much light is transmitted. This effect is substantially excluded by the central reflector. An exemplary known alternative to a diffractive optical element is a Fresnel lens.

The optical element is preferably integrated into a front screen of the illumination apparatus or of the 3D camera. In this way the front screen satisfies a double function, whereby construction space and manufacturing costs can be saved.

The light source preferably has an LED or an array of LEDs. Also a laser illumination is plausible, in particular in the form of a VCSEL array, however, is not necessarily required in contrast to many common solutions which strive for a structured illumination pattern of high intensity. A plurality of LEDs ensure a higher optical output performance. In this connection a light illumination of the scenery should be ensured by the LEDs. In this case variations in performance through diverse shifts, such as temperature effects, aging effects or noise effects or even through individual failures can be averaged out and/or all pixels of the 3D camera are effected in the same way so that no systematic measurement error is introduced. Such variations in performance then also have no such large an influence on the overall system and do not lead to partial failures in certain image regions. At the same time the requirement of a plurality of optical reference paths for the time of flight of light measurement for individual pixels is obsolete.

In an advantageous embodiment a 3D camera is provided having a least one illumination apparatus in accordance with the invention. This 3D camera can be based on an arbitrary 3D method; however, is preferably configured as a 3D camera in accordance with the principle of time of flight of light and for this purpose has an image sensor with a plurality of pixel elements, as well as an evaluation unit in order to determine a time of flight of light between transmission and reception of light of the illumination apparatus for each pixel element. The evaluation unit can be integrated at least partly into the image sensor in such a way that Intelligent pixels thus arise which themselves take on at least parts of the determination of the time of flight of light. Such a method is known as photon mixed detection (PMD).

The method in accordance with the invention can be improved in a similar manner and in this connection shows similar advantages. Such advantageous features are described by way of example, but not conclusively in the dependent claims adjoining the independent claims.

The invention will be described in the following in detail also with respect to further features and advantages by way of example with reference to embodiments and on the basis of the submitted drawing. The images of the drawing show in:

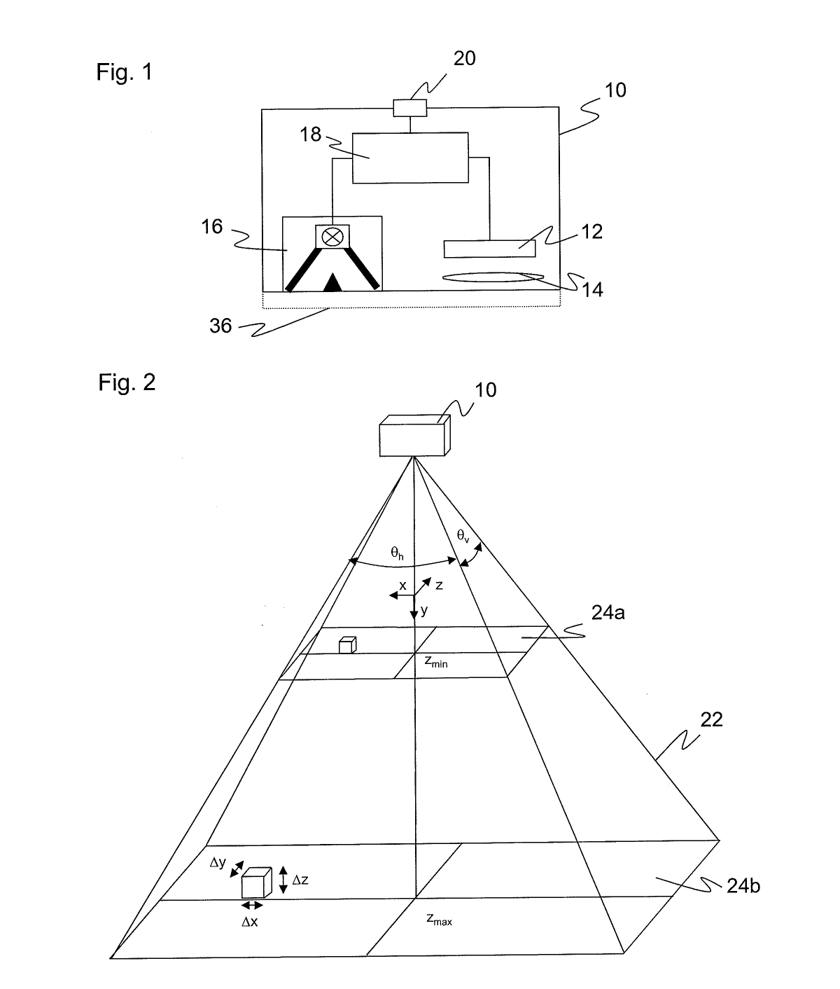

FIG. 1 a simplified block illustration of a 3D camera and its illumination apparatus;

FIG. 2 a three-dimensional representation of the viewing field of the 3D camera;

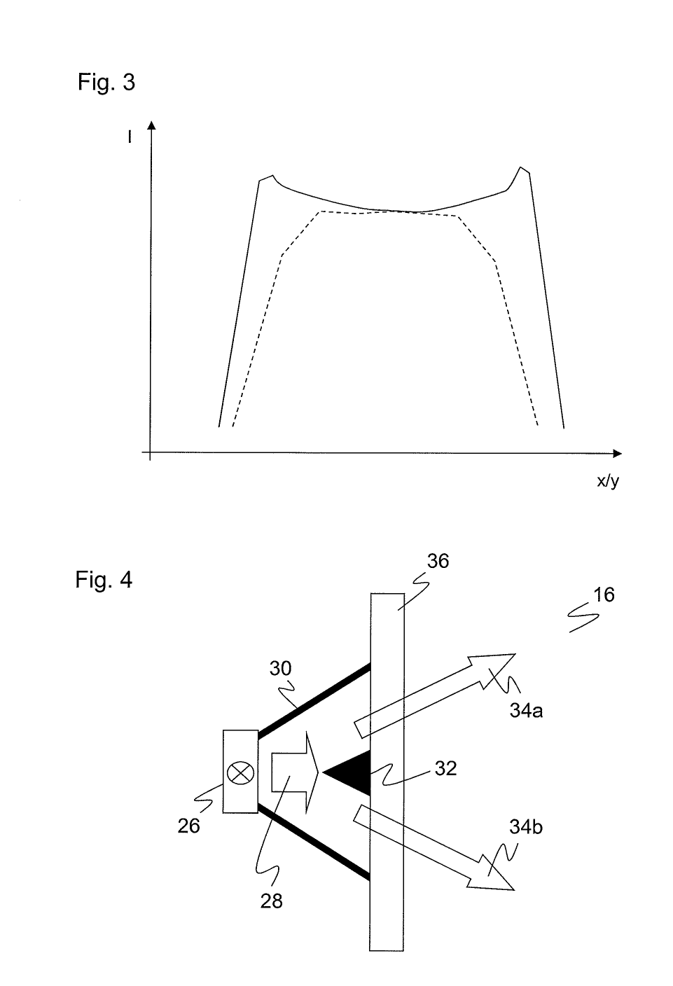

FIG. 3 a comparison of a common intensity distribution in dependence on the lateral position with boundary drop and an intensity distribution in accordance with the invention with an excessive boundary region;

FIG. 4 a simplified illustration of an embodiment of an illumination apparatus having a lateral reflector and a central reflector;

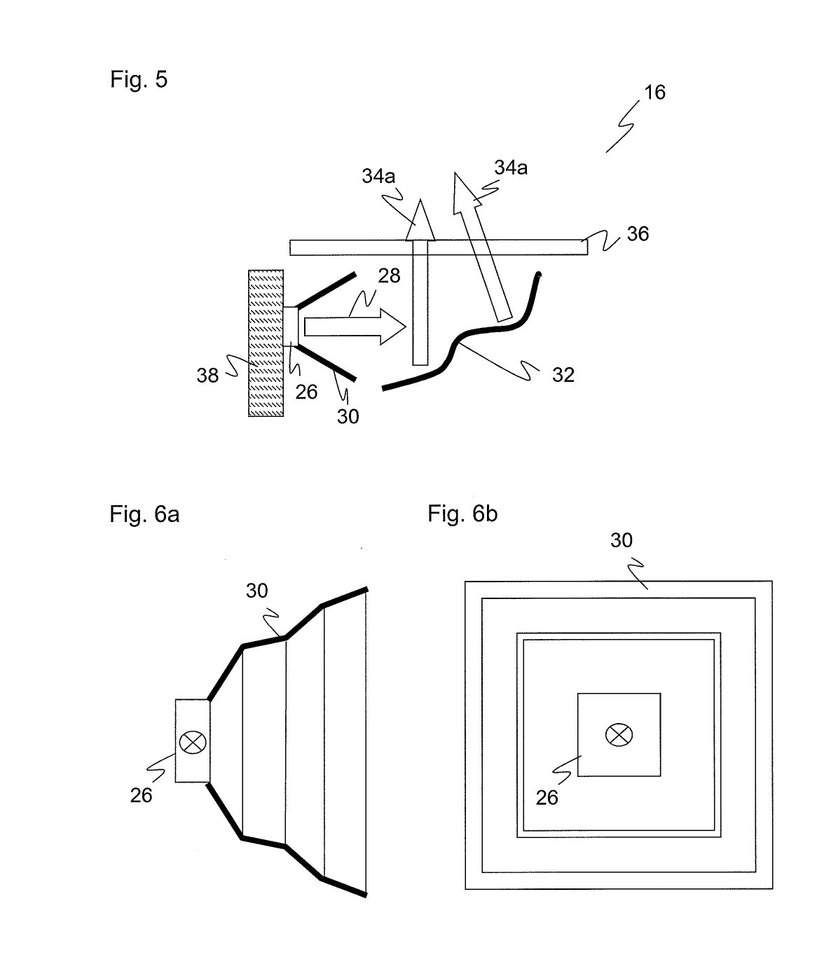

FIG. 5 a simplified illustration of an embodiment of an illumination apparatus with mirrored elements; and

FIGS. 6a-b a side view and a top view respectively onto a further embodiment of a lateral reflector with stacked or convoluted truncated pyramids.

FIG. 1 shows a simplified block illustration of a 3D camera 10 having an image sensor 12 which has a plurality of light sensitive pixel elements and in front of which a reception objective 14 is arranged which for reasons of simplicity is illustrated as an individual lens. The 3D camera 10 further comprises an illumination apparatus 16 whose elements and functional principle will only be described in detail in the following in connection with FIG. 4. The optical arrangement of the image sensor 12 and of the illumination apparatus 16 is only to be understood by way of example, the shown mutual spacing should not play a role with respect to the scenery to be assumed. Alternative embodiments having dividing mirrors or otherwise coaxial arrangements are plausible. Moreover, the illumination apparatus 16 described by way of a 3D camera 10 is in principle also suitable for other sensors, for example for 2D cameras.

A control and evaluation unit is connected to the image sensor 12 and to the illumination apparatus 16 in order to read out pixel resolved image data of the image sensor 12 and to evaluate these including a distance determination, for example, by a determination of a time of flight of light, and/or in order to illuminate a scenery via the illumination apparatus 16 in a desired manner, for example, with illumination pulses or amplitude modulated light. Image data is output in different states of processing via an interface 20, or the 3D camera 10 is parameterized in a different way via the interface 20 or via a further interface. The evaluation can at least partly already take place in the pixels of the image sensor 12 or vice versa also outside of the 3D camera 10 which then merely provides corresponding raw data at the interface 20.

The 3D camera 10 preferably works in accordance with a time of flight of light method, however, this is generally known and for this reason is not explained in further detail. Alternatively, the 3D camera 10 can also use a different 3D method, such as stereoscopy, wherein then, under some circumstances, an additional pattern element is used in the illumination apparatus in order to obtain a structured illumination pattern rather than a homogeneous illumination. The boundary drop effect compensated by means of the invention relates to such illumination patterns in a very similar manner.

FIG. 2 shows a schematic three-dimensional illustration of the 3D camera 10 with its visible region 22. For an active image detection the visible region 22 preferably lies within an illuminated region of the illumination apparatus 16 and/or in the ideal case coincides therewith. The 3D camera 10 should have a geometric resolution of objects Δx, Δy, Δz which only depends on the spacing z with respect to the 3D camera 10. Within a distance plane 24a having a fixed spacing z between a minimum distance zₘᵢₙ and a range zₘₐₓ the object resolution Δx, Δy, Δz should thus remain independent of the position x, y within the distance plane 24a-b.

Having regard to the lateral resolution Δx, Δy this is generally provided, since these are dependent on the measurement principle, on the evaluation algorithm, as well as generally on the same properties and dimensions for all pixels of the image sensor 12. The distance resolution or axial resolution Δz in contrast to this shows a dependency on the detected light power and/or of the signal power. The signal power in turn however depends on the lateral position x, y. As firstly the illumination intensity of a semiconductor light source of the illumination apparatus 16 laterally decreases from an intensity maximum in the center, this means decreases laterally along the optical axis. Secondly, even for a completely homogeneous illumination a boundary drop of the receiving objective 14 would still remain which leads to a reduction of the detected light power in boundary pixels of the image sensor 12. For this reason a systematic increased measurement insecurity in the boundary regions and in particular in the edges of the image sensor 12 and/or of the viewing region 22 result without additional measures.

FIG. 3 shows a comparison of a lateral intensity distribution illustrated with a dotted line with respect to the compensated boundary drop and a lateral intensity distribution with an excessive boundary region illustrated with a continuous line for its compensation. For this purpose illumination energy is redistributed into the boundary region in accordance with the invention. As can be recognized in FIG. 3 the boundary region drop is not only preferably compensated to a constant intensity distribution. Rather more, the illumination intensity in the boundary region is even further suitably increased in order to also compensate a boundary region drop of the reception objective 14.

More specifically, at least two effects have to be considered for the compensation of lateral position dependencies of the receiving objective 14. A first effect is the boundary region drop, already discussed a plurality of times, which ensures that the intensity decreases with a first factor k₁ with respect to the spacing towards the center. A second, typically smaller effect is introduced by the distortion of the receiving objective 14 due to which the effective surface in the objective plane which is imaged onto every pixel of the image sensor increases with respect to the spacing to the center by a second factor k₂. This effectively results in a certain intensity increase with respect to the boundary which to a certain degree counteracts the boundary region drop. For this reason, the illumination intensity as a whole should be modified with a factor k₁/k₂ dependent on a spacing with respect to the center in order to compensate both effects.

FIG. 4 shows an illustration of the illumination apparatus 16. A semiconductor light source is preferably provided as a light source 26. Depending on the embodiment it is a laser diode, an LED, or an array of such light sources. The light source 26 can have a non-shown additional transmission optics in the form of, for example, lenses, back reflectors, and/or apertures in order to generally radiate the light, at least coarsely, in the main radiation direction 28 along the optical axis indicated with an arrow.

The illumination apparatus 16 has a circumferentially arranged lateral reflector 30 which in this example is exemplarily illustrated as having the shape of an inner mirror-coated hollow cone. A central reflector 32 is additionally provided at the optical axis which in the sectional illustration is triangular and from a spatial consideration has the shape of a wedge or of a hollow cone with outer mirrored jacket surfaces. In this connection the axis of symmetry of the central reflector 32 and the optical axis of the light source 26 coincide and the tip of the central reflector 32 points in the opposite direction with respect to the main radiation direction 28. Other embodiments with asymmetric arrangement are, however, also plausible.

The central reflector 32 deflects central light portions of the light source 28 initially onto the lateral reflector 30 and then into the boundary region of the illuminated version or the visible region 22. The lateral reflector 30 thus serves the purpose, on the one hand, to bring about a deflection of the central light portions, as indicated by the two arrows 34a-b, outwardly, and, on the other hand, to bring about a deflection of completely peripheral light portions towards the boundary region, as well as of complete outer light portions inwardly. This also has the effect that the central regions of the illuminated region 22 shaded in the direct light part are sufficiently illuminated. An intensity distribution with boundary increase can be achieved in this way, as is, for example, illustrated by way of example with a continuous line in FIG. 3 through a suitable selection of the angles of the lateral reflectors 30, of the central reflector 32, as well as of the respective size and arrangement.

Multiple reflections between the lateral reflector 30 and the central reflector 32 are prevented by acute angles of at most 45° , preferably of at most 30° or of at most 20° of the central reflector 32. So that the light redistribution from the outside towards the inside by the lateral reflector 30 actually brings about a sufficient illumination of the central region and the excess boundary region obtains a sufficient level, the lateral diameter of the central reflector 32 should remain considerably smaller than that of the lateral reflector 30, in particular be at most half the size or even amount to at most a third or to a quarter. The wedge angle and/or the conical angle of the central reflector preferably corresponds, but not necessarily, to half the opening angle of the illuminated region and/or of the visible region 22 of the 3D camera 10. As an alternative to the shown embodiment of the central reflector 32 having a triangular cross-section, also parabolic shapes or even free form surfaces are plausible, wherein the respective shape and extent of the radiation characteristics of the light source 28, as well as the desired intensity distribution are matched. In this connection the shape does not necessarily have to be rotationally symmetric also when this is preferably the case.

The 3D camera 10 has a front disc 36 for its protection through which the light of the illumination apparatus 16 passes. Further optical elements can be integrated into this front disc 36 in order to achieve the desired redistribution. Alternatively, also non-shown additional optical elements could be introduced into the optical path of the illumination apparatus 16.

In an embodiment such an optical element is provided in the shape of a diffractive optical element. Practically any desired intensity distribution and in this way also an effective, homogeneous illumination can be achieved through a corresponding design, this means after a consideration of any imaging error of the receiving objective 14. In this connection the optical element cooperates, preferably with the lateral reflector 30 and the central reflector 32, could generally also ensure the desired redistribution on its own.

If an LED is used as a light source one would not generally use a diffractive optical element, since its optimization is designed with respect to a certain wavelength and a direction of incidence which could not be maintained by the bandwidth and large divergence of an LED. Thus, parasitic diffraction effects especially of the 0^{th} order are present.

The homogeneous illumination considered in this example, is not in contradiction to a strong 0^{th} order of diffraction order, since only a part of the light should in any event be redistributed outwardly. For this purpose, it is sufficient to use higher orders of diffraction, such as the ±1 order for the redistribution outwardly. For this reason it is possible without further ado to design a corresponding diffractive optical element for a homogeneous illumination with boundary region excess in dependence on the radiation characteristic of the LED used it is.

Also the angular dependency of the diffractive optical element can in this connection be considered and/or advantageously be used with respect to the design. For this purpose, for example, the redistribution generally takes place in the center near the optical axis of the LED, where the input intensity is high. A reduction of the redistribution efficiency with a decreasing spacing from the optical axis is in this event even desired, since the intensity should be increased at the boundary and not be reduced by the redistribution.

A drift in wavelength is very problematic for lasers and is, for example, prevented by temperature compensations. Having regard to LEDs with their large bandwidth a wavelength drift is of lesser importance, since from the start a larger tolerance is planned with respect to the wavelength of the incident light. From the start one can even select the design wavelength of the diffractive optical element so that it targetly deviats from the LED wavelength, since in any event no maximum diffraction efficiency is required. This reduces the susceptibility with respect to wavelength drifts even further.

In a special embodiment of such a diffractive optical element a chirped grid structure is used in which the grid constant is at a maximum in the center, this means at the optical axis and then linearly reduces towards zero towards the sides. In this way the maximum intensity is redistributed from the center towards the boundary. The further one moves away from the optical axis, the smaller the grid frequency and/or the line number per millimeter becomes so that the redistribution angle continuously decreases. From a certain spacing towards the center, for example, at a half spacing to the boundary no grid structure is then no longer present so that also no redistribution can take place in the boundary region.

In an alternative embodiment a Fresnel lens is provided instead of a diffractive optical element. In this way no parasitic orders of diffraction are present and also the efficiency problem is not present to the same degree. Overall, the degrees of freedom are reduced, in this way, however, also, the demand with respect to the design. Having regard to a common refractive lens the advantage of a Fresnel lens consists in its flat construction shape which also permits the simple integration into the front disc 36, in particular at its inner side.

FIG. 5 shows an alternative embodiment of the illumination apparatus 16. The central reflector 32 is configured in this example in the form of a laterally irradiated mirror contour, which is irradiated not from the front but substantially at an angle of 45° . Thereby also the overall arrangement and orientation changes since the light source 26 is now tilted by 90° . Practically, any arbitrary intensity distributions can be achieved by means of the mirror contour. An additional advantage of this arrangement consists therein, that the at least one light source 26 can be attached at a lateral housing wall 38 which simplifies the thermal connection and the discharge of heat losses.

FIG. 6a in a side view and FIG. 6b in a top view show an alternative embodiment of the lateral reflector 30. In this connection, at least two, in the specifically illustrated example four truncated pyramids, specifically hollow truncated pyramids are stacked on top of one another. Through the different angles and heights of the truncated pyramids the degrees of freedom of adaption with respect to the radiation characteristics of the light source 26 and with respect to the desired illumination distribution in the illuminated region 22 result. For reasons of simplicity a central reflector 32 is not shown in the FIG. 6, but is preferably provided in analogy to FIG. 4. On the other hand, it is also plausible in a further embodiment to omit the central reflector 32, in particular for light sources 26 having a large radiation angular range.

What is claimed is:

1. An illumination apparatus (16) for a 3D camera (10) for the generation of an illuminated region (22) having a homogenous intensity distribution which is nevertheless an increased intensity distribution in the boundary regions of the illuminated region (22), wherein the illumination apparatus (16) comprises:
at least one light source (26) having a main radiation direction, as well as a lateral reflector (30) circumferentially arranged about the main radiation direction (28),
wherein an additional central reflector (32) is arranged in the main radiation direction (28) in order to redistribute central light portions of light transmitted by the light source (26) outwardly by reflection at the central reflector (32) and at the lateral reflector (30).

2. The illumination apparatus (16) in accordance with claim 1, wherein the lateral reflector (30) has the shape of a hollow cone or of a hollow pyramid.

3. The illumination apparatus (16) in accordance with claim 1, wherein the lateral reflector (30) has the shape of at least two hollow truncated cones arranged on top of one another or of at least two hollow truncated pyramids arranged on top of one another.

4. The illumination apparatus (16) in accordance with claim 1, wherein the central reflector (32) has a tapering shape.

5. The illumination apparatus (16) in accordance with claim 1, wherein the central reflector (32) has a rotationally symmetric shape.

6. The illumination apparatus (16) in accordance with claim 1, wherein the central reflector (32) has the shape of a wedge or of a sphere.

7. The illumination apparatus (16) in accordance with claim 1, further comprising an optical element (36) in the optical path of the light source (26) for the additional redistribution of light, the optical element being arranged downstream of the lateral reflector (30) and of the central reflector (32).

8. The illumination apparatus (16) in accordance with claim 7, wherein the optical element (36) comprises one of a diffractive optical element and a Fresnel lens.

9. The illumination apparatus (16) in accordance with claim 7, wherein the optical element is integrated into a front screen (36) of the illumination apparatus (16) or of the 3D camera (10).

10. The illumination apparatus (16) in accordance with claim 1, wherein the light source (26) comprises an LED or an array of LEDs.

11. A 3D camera (10) having at least one illumination apparatus (16) comprising:
at least one light source (26) having a main radiation direction, as well as a lateral reflector (30) circumferentially arranged about the main radiation direction (28),
wherein an additional central reflector (32) is arranged in the main radiation direction (28) in order to redistribute central light portions of light transmitted by the light source (26) outwardly by reflection at the central reflector (32) and at the lateral reflector (30).

12. A 3D camera (10) in accordance with claim 11, which is configured as a 3D camera (10) in accordance with the principle of time of flight of light and which comprises an image sensor (12) having a plurality of pixel elements, as well as an evaluation unit (18) in order to determine a time of flight between transmission and reception of light of the illumination apparatus (16) for each pixel element.

13. A method for the generation of an illuminated region (22) for a 3D camera (10) having a homogenous intensity distribution which is nevertheless an increased intensity distribution in the boundary regions of the illuminated region (22), wherein outer portions of light which is transmitted from a light source (26) in a main radiation direction (28) is redistributed with respect to a center of the illuminated region (22) by a lateral reflector (30) circumferentially arranged about the main radiation direction (28),
further comprising the step of redistributing central light portions of the light outwardly by reflection initially at a central reflector (32) arranged in the main radiation direction (28) and then by reflection at the lateral reflector (30).
